(19) United States
(12) Patent Application Publication
(10) Pub. No.: US 2008/0210755 A1
(43) Pub. Date: Sep. 4, 2008

(54) Prescription medication information reading system

(76) Inventor: Salvatore Salzarulo, Watchung, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/998,342

(22) Filed: Nov. 29, 2007

Related U.S. Application Data
(60) Provisional application No. 60/861,839, filed on Nov. 30, 2006.

(51) Int. Cl. G06Q 30/00; G06Q 50/00

(52) U.S. Cl. 235/385; 705/2

(57) ABSTRACT

A reading device includes a housing having a receptacle for receiving at least part of a container, an interface operable to initiate communication with a destination device upon the receptacle receiving the at least part of the container, and a reader operable to read an identifier located on the container. The interface is further operable to transmit the identifier to the destination device and to receive from the destination device information associated with the identifier.

### CROSS-REFERENCE TO RELATED APPLICATIONS

This application claims the benefit of the filing date of U.S. Provisional Application No. 60/861,839, filed Nov. 30, 2006, the disclosure of which is hereby incorporated by reference herein.

### BACKGROUND OF THE INVENTION

The present invention is directed to data systems and, more particularly, to systems for obtaining information associated with the contents of a container, such as information concerning a prescription medication and concerning a user who is prescribed such medication.

Stores that provide prescription or non-prescription medications, vitamins, supplements, and the like, such as pharmacies and health food stores, have attempted various ways of providing safety information and other information to consumers. For example, stores have used large, colorful labels that may include symbols or pictures that provide information such as the proper dosage and storage as well as possible interactions. However, the small sizes of most medication containers limit the size of these labels so that only small-sized text may be accommodated. As a result, such labels are difficult to read, even by an individual having normal vision. Moreover, pharmacies are adding an increasing number of such labels which results in a clutter of labels on the container, thereby increasing the difficulty of reading any particular one of the labels as well as reducing the likelihood that such labels will be read. Further, medications are often prescribed to non-English speaking individuals who would not understand the warnings and information provided by these labels even if such labels are readable. As a result, tens of thousands of accidental overdoses of medications occur every year, and numerous instances of adverse interactions between medications also occur. It is therefore desirable to provide a system that addresses these problems.

### SUMMARY OF THE INVENTION

In accordance with an aspect of the invention, a reading device includes a housing having a receptacle for receiving at least part of a container, an interface operable to initiate communication with a destination device using the address after the receptacle receives the at least part of the container, and a reader operable to read an identifier located on the container. The interface is further operable to transmit the identifier to the destination device and, in response, to receive from the destination device information associated with the identifier.

In accordance with another aspect of the invention, information relating to a container is obtained using a method that includes receiving at least part of the container in a receptacle located in a housing, initiating communication with a destination device after the receiving of the at least part of the container, reading an identifier located on the container, transmitting the identifier to the destination device, and receiving from the destination device information associated with the identifier.

In accordance with yet another aspect of the invention, a reading device includes a housing having an receptacle for receiving at least part of a container, a reader operable to read an identifier located on the container, a storage unit operable to store an address of a destination device, and an interface operable to transmit the identifier to the destination device after the receptacle receives the at least part of the container and to receive from the destination device information associated with the identifier.

In accordance with the above aspects of the invention, a switch may be operable to detect that the at least part of the container is received in the receptacle. A storage device may be operable to store the address of the destination device, and a processor may be operable to obtain the address of the destination device from the storage device. The address of the destination device may be a telephone number, and the interface may include an autodialer. The address of the destination device may be a network address, and the interface include a network interface. The network address may be a URL for the Internet. The container may be a prescription medication container, and the information associated with the read identifier may be selected from the group consisting of a patient name, an age of the patient, a physician name, a physician telephone number, a pharmacy name, a pharmacy address, a pharmacy telephone number, a medication name, a medication dosage, a frequency at which the medication is to be taken, a manner in which the medication is to be taken, an ailment for which the medication is being prescribed, a physical description of the medication, a marking on the medication, a preferred range of dosages, the size of each unit of medication, a weight of each unit of medication, a special warning, a special instruction, an expiration date of the medication, a proper storage condition for the medication, a possible side effect of the medication, a recommendation to avoid a side effect of the medication, drug interaction information, a Food and Drug Administration (FDA) update, an FDA warning, recall information, Physician's Desk Reference (PDR) information on the medication, a PDR update on the medication, existence of a generic form of the medication, and combinations thereof. The interface may be operable to communicate with a pharmacy associated with the destination device. The interface may be operable to communicate with a data center associated with the destination device. At least a portion of a bottom surface of the receptacle may include a material that frictionally engages an end portion of the container. The material may be a gum or rubber. The information obtained from the destination device may include audio data, and the reading device may further include a speaker operable to output the audio data. The information obtained from the destination device may include text data, and the reading device may further include a processor operable to generate audio data from the text data and a speaker operable to output the generated audio data. The receptacle and the container may have complementary non-circular cross-sections such that when the container is inserted into the receptacle, the container and the walls of the receptacle interact to prevent the container from rotating. The identifier may be read from a storage medium selected from the group consisting of an audio label, a semiconductor chip, a bar code label, an electrical storage medium, a magnetic storage medium, and an optical storage medium. The storage medium may further store information selected from the group consisting of a patient name, an age of the patient, a physician name, a physician telephone number, a pharmacy name, a pharmacy address, a pharmacy telephone number, a medication name, a medication dosage, a frequency at which the medication is to be taken, a manner in which the medication is to be taken, an ailment for which the medication is being prescribed, a physical description of the medication, a marking on the medication, a preferred range of dosages, the size of each unit of medication, a weight of each unit of medication, a special warning, a special instruction, an expiration date of the medication, a proper storage condition for the medication, a possible side effect of the medication, a recommendation to avoid a side effect of the medication, drug interaction information, a Food and Drug Administration (FDA) update, an FDA warning, recall information, Physician's Desk Reference (PDR) information on the medication, a PDR update on the medication, existence of a generic form of the medication, and combinations thereof. A scale may be operable to weigh the container, and may weigh the container after the receptacle receives the at least part of the container. A display may be operable to display at least part of the information associated with the identifier. At least part of the information associated with the identifier may be selected from the group consisting of text data, image data, audio data, and combinations thereof.

The foregoing aspects, features and advantages of the present invention will be further appreciated when considered with reference to the following detailed description and accompanying drawings.

### BRIEF DESCRIPTION OF THE DRAWINGS

FIG. 1A is an overhead perspective view of a prescription medication bottle reading device according to an embodiment of the invention; and FIG. 1B is a perspective view of the device shown in FIG. 1A and showing the insertion of a prescription medication bottle therein.

FIG. 2A is a perspective view of an example of a prescription medication bottle in accordance with the invention; and FIG. 2B is a bottom perspective view of the prescription medication bottle shown in FIG. 2A.

FIG. 3 is a partial perspective view a prescription medication bottle reading device according to another embodiment of the invention.

FIG. 4 is a block diagram showing an example of a prescription medication information system in accordance with the invention.

FIG. 5 is a block diagram showing an example of the functional elements of the reading device shown in FIG. 1A.

FIG. 6 is an overhead perspective view of a prescription medication bottle reading device according to a further embodiment of the invention.

FIG. 7 is a perspective view of another example of a prescription medication bottle in accordance with the invention.

FIG. 8 is a block diagram showing an example of the functional elements of the reading device shown in FIG. 6.

FIG. 9 is an overhead perspective view of a prescription medication bottle reading device according to a still further embodiment of the invention.

FIGS. 10A and 10B are diagrams illustrating examples of data strips used with a prescription medication bottle in accordance with another aspect of the invention.

### DETAILED DESCRIPTION

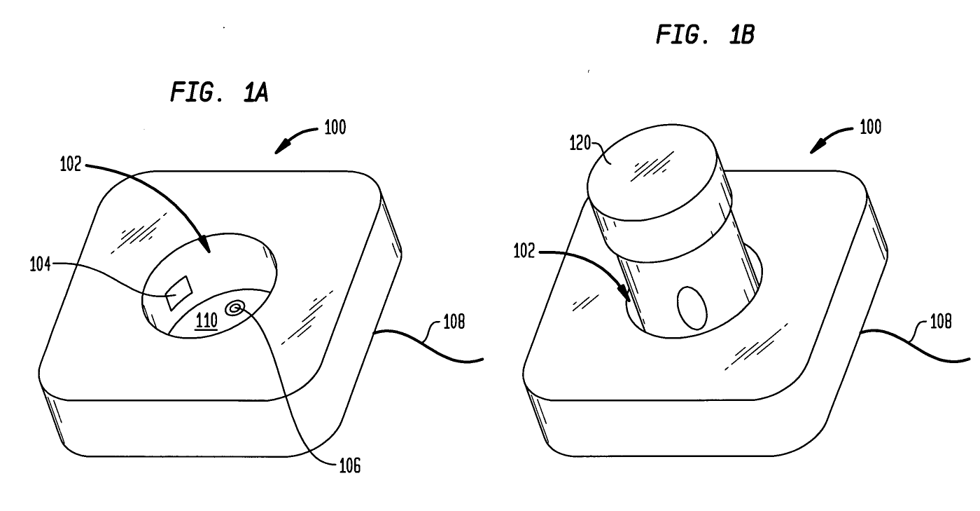

FIG. 1A depicts an overhead perspective view of a reading device 100 in accordance with an embodiment of the invention. A receptacle 102 is formed in an opening in a top surface of the device 100. The receptacle includes a reader 106 for reading a code number or other identifier located on the surface of a container 120 that is inserted into the receptacle 102, as shown in FIG. 1B. A switch or sensor 104 may be provided to detect the presence of the container in the receptacle and then activate the reader 106. Alternatively, the reader 106 may be activated upon contacting the container or may always remain on. A bottom surface 110 of the receptacle may be formed of a material, such as a gum or rubber, that frictionally engages the bottom of the container 120 to inhibit rotation of the container in the receptacle, and thus assists a user in opening the container.

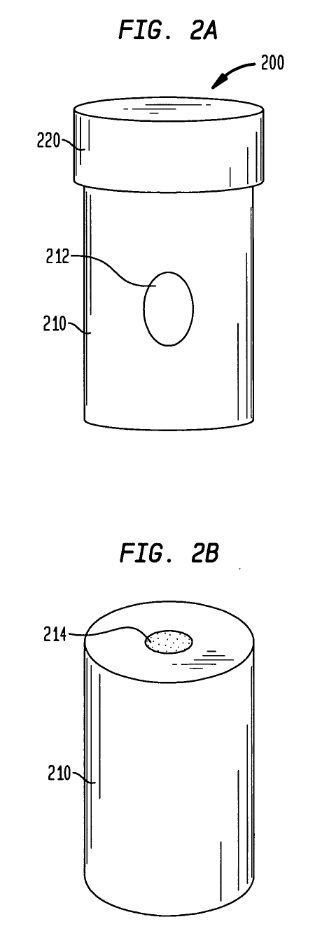

FIGS. 2A and 2B illustrate a container 200 in accordance with an embodiment of the invention. The container includes a holding portion 210 and a cap 220. When the container is used to hold prescription medication, non-prescription medication, vitamins, etc. in the form of pills, capsules, tablets or caplets, for example, the cap 220 may be a safety cap. A fingerprint identifier 212 may be provided on the surface of the holding portion 210. When the reading device 100 includes an optical scanner or other sensor 104, the fingerprint identifier 212 may be positioned to be readable by the sensor 104. The fingerprint identifier may be used to identify a user of the reading device 100. Alternatively, or additionally, the fingerprint identifier may be used as a backup to a storage medium 214 in the event of, for example, damage to the storage medium.

The storage medium 214, which may be a computer chip, a magnetic strip, or other electrical, magnetic, or optical storage medium, is also disposed on the surface of the holding portion 210 and positioned such that when the container is inserted into the reading device 100, the reader 106 is able to read the storage medium 214. As an example, FIG. 2B shows the storage medium 214 located on a bottom surface of the holding portion 210 so as to be readable by the reader 106 located on the bottom surface of the receptacle 102 of the reading device. The storage medium 214 holds at least a code number or other identifier that is associated with, for example, the contents of the container. As an example, when the container is used to hold prescription medication, the storage medium 214 may hold at least a code number or other identifier that is associated with a particular filled prescription. The code number or other identifier may be read into and stored in the storage medium 214 at a pharmacy at about the time that a pharmacist fills a patient's prescription. For example, the container 200 may be supplied to the pharmacy with the storage medium 214 already attached, and at about the same time that the prescription is filled, the pharmacist or a clerk may insert at least part of the container 200 into a device having a receptacle similar to the receptacle 102 of the reading device 100 shown in FIG. 1 except that, either in place of or in addition to the reader 106, a write head or the like is provided for reading into the storage medium 214. The pharmacist or clerk may enter the code number or other identifier into a personal computer (PC), or the like, that is connected to or in communication with the device into which the at least part of the container 200 is inserted to have the code number or other identifier stored in the storage medium 214. Alternatively, or additionally, the pharmacist or clerk may enter the code number or other identifier into a PC, or the like, that is connected to or in communication with a printer which prints a label, such as a bar code label, that serves as the storage medium. The pharmacist or clerk then attaches the label to the container 200. As another alternative, or as another addition, the code number or other identifier may be read into and stored in a blank formatted magnetic strip using a PC, or the like, in the manner described above and using a known reader/writer device, and the magnetic strip is then attached to the container 200.

At about the same time, the code number or other identifier is also entered into a database, such as by the pharmacist or clerk, using a PC, or the like, which holds the database or which is in communication with another computer in which the database is located. The database may be located, for example, at the particular pharmacy, at a central storage location for a pharmacy chain, or at another data center. Other information may also be stored in the database in association with the code number or other identifier. Such information may include the patient's name, address, and/or telephone number, the name, address and/or telephone number of the prescribing physician or other health care provider, the name of the medication, the prescribed dose, the quantity of medication contained in each tablet, capsule, caplet or the like, the frequency at which the medication is to be taken, etc.

Alternatively, the code number or other identifier may be stored in the storage medium 214 prior to the filling of the patient's prescription, such as at the time the storage medium is manufactured or at the time the storage medium is affixed to the container. The previously stored code number or other identifier may be read from the storage medium 214, such as by the pharmacist or clerk, at the time that the prescription is filled. The code number or other identifier may then be entered into the database and stored in association with other information as described above.

As another example, when the container is used to hold non-prescription medication, vitamins, supplements, etc., the code number or other identifier may be stored in the storage medium 214 at the time of purchase, such as by an employee of the pharmacy, health food store, etc. The code number or other identifier may then be entered into a database, such as by the employee. Other information, such as the purchaser's name, address, and/or telephone number, the type of medication, vitamin, supplement, or the like that was purchased, the quantity contained in each tablet, capsule, caplet or the like, etc. may also be stored in the database in association with the code number or other identifier. The database may be located, for example, at the particular pharmacy or store, at a central storage location for a chain of pharmacies and/or stores, or at another data center. Alternatively, the code number or other identifier may be stored in the storage medium 214 at a time prior to the purchase as described above, may be read from the storage medium 214 at the time of purchase, and may be entered into the database and stored in association with the other information.

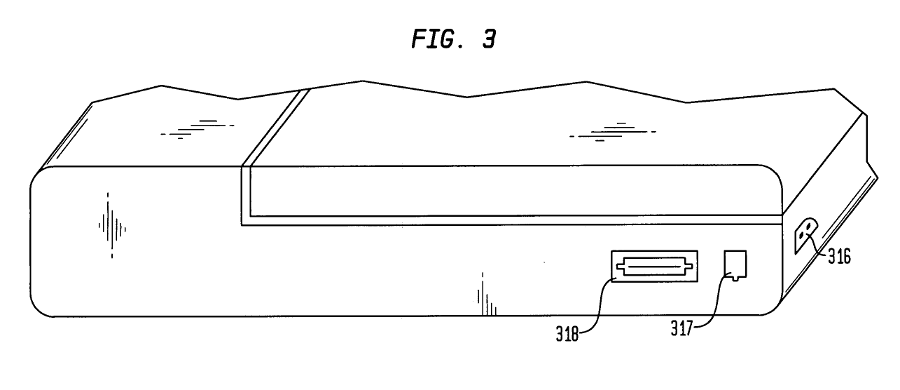

FIG. 3 depicts an example of a back portion of the reading device which includes a power cord connection terminal 316. One or more additional terminals are included to provide external connections for the reading device. As an example, a telephone jack 317 may be provided for connection to the telephone network in a user's home. In another example, a further terminal 318 may be provided for connection to a data network, such as an Ethernet local area network.

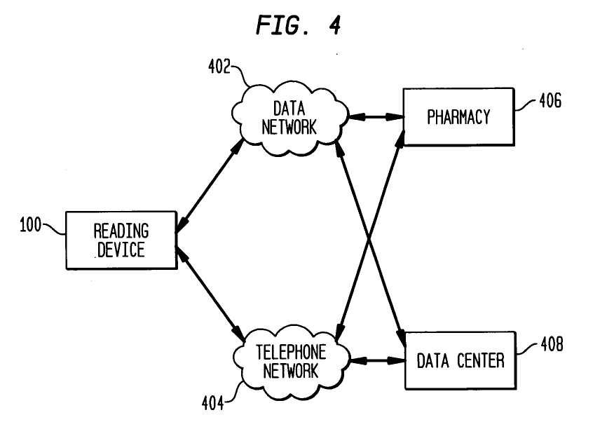

FIG. 4 shows a reading device 400 connected through a telephone network 404, such as by using the telephone terminal jack 317 shown in FIG. 3, to a pharmacy 406, which may be a local pharmacy or other pharmacy, and/or to a data center 408 of, for example, a pharmacy chain. Additionally, or alternatively, the reading device 400 may be connected through a data network 402, such as the Internet, to the pharmacy 406 and/or the data center 408. Such a connection to the data network may be provided, for example, through the telephone jack 317 or the data terminal jack 318 shown in FIG. 3.

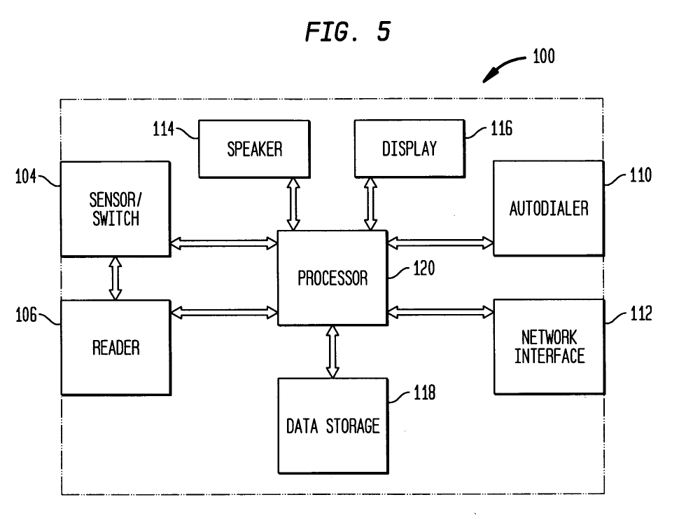

FIG. 5 is a block diagram illustrating various functions carried out by a reading device in accordance with an embodiment of the invention. Though separate functional blocks are shown, some or all of the depicted functions may be combined in a single physical unit.

When a pill container or other container is inserted into the receptacle 102 of the reading device 100, the sensor or switch 104 and/or the reader 106 detects the presence of the container and notifies a processor 120 which then reads a telephone number or other address of a destination device from a data storage unit 118. When a telephone number is read from the data storage unit 118, the processor delivers the telephone number to an autodialer 110 which then initiates a telephone call to the telephone number and establishes communication with the destination device through the telephone network. Alternatively, when other address information is read from the data storage unit 118, such as a uniform resource locator (URL), the processor may deliver the address to a network interface 112 which then establishes a data connection with the destination device over a data network, or the processor may instruct the autodialer 110 to provide a telephone connection to an Internet service provider (ISP), and communication with the destination device may be initiated through the Internet in this manner. As an example, the destination device may be the pharmacy 406 or the pharmacy chain or other data center 408 shown in FIG. 4.

After communication with the destination device has been established, the processor 120 instructs the reader 106 to read the contents of, for example, the storage medium 214 located on the container 200 shown in FIGS. 2A-2B. Alternatively, the reader 106 may read the contents of the storage medium concurrent with the initiation of communication with the destination device. The reader 106 thus obtains a code number, or other identifier, from the storage medium of the container and delivers same to the processor 120. The processor 120 may then transmit the code number or other identifier to the destination device over the telephone network using the established telephone connection or over the data network using the established network connection.

Upon receiving the code number or other identifier, the destination device looks up stored information associated with the received code number or other identifier, and then transmits the obtained information over the telephone network or data network for delivery to the reading device 100. As an example, when the container inserted into the reading device contains prescription medication, the reading device may obtain information relating to the prescription medication from the pharmacy or from the data center. Such information may include, for example, one or more of the patient's name, the age of the patient, the name of the medication, the prescribed dosage, the frequency at which the medication is to be taken, the manner in which the medication is to be taken, the ailment for which the medication is being prescribed, the prescribing physician's name and/or telephone number, the issuing pharmacy's name and/or telephone number, the physical description of the medication and any markings thereon, the preferred range of dosages, the size or weight of each pill, capsule, caplet, or the like, special warnings, special instructions, the expiration date of the medication, proper storage conditions for the medication, possible side effects of the medication, recommendations to avoid such side effects, information regarding other medications or foods that may adversely affect or counteract the prescribed medication, Food and Drug Administration (FDA) updates and warnings, recalls of medications, Physician's Desk Reference (PDR) information and updates on the prescribed medication, the existence of a generic form of the prescribed medication, and the like. When the container holds a non-prescription medication, the received information may include information concerning the ingredients or related nutritional information, side effects, interactions, recommended doses, complementary supplements, ailments treated, etc., as well as some or all of the above-listed information.

The received information may be provided in the form of text data, audio data, and/or image data. As an example, when the received information includes audio data, the processor 120 may deliver some or all of the audio data to a speaker 114. Additionally, or alternatively, the processor 120 may convert received text data into speech for delivery to the speaker 114. Moreover, the processor may deliver some or all of the received text data and/or image data to a display 116 according to a predefined format. Further, the processor may arrange a portion of the received text and/or image data in menu form for delivery to the display 116. The patient may then select from the displayed menu to view additional information on the display 116 or to hear the additional information from the speaker 114. One or more of the menu items may permit the patient to request to speak to the physician or pharmacist, and when such an item is chosen, a telephone call using the appropriate telephone number may be initiated using the autodialer 510. One or more other menu items may prompt the patient to request (PDR) information and/or updates regarding the prescribed medication from the destination device. The PDR information may be stored at the destination device and/or may be obtained by the destination device from the PDR web site or other storage location at the time of the request.

Alternatively, when the pill container or other container is inserted into the receptacle 102 of the reading device 100, the sensor or switch 104 may detect the presence of the container and cause the reader 106 to read the contents of the storage medium 214. Alternatively, the sensor or switch 104 may notify the processor 120 which in turn causes the reader 106 to read the contents of the storage medium. The reader 106 may read the code number or other identifier from the storage medium and deliver same to the processor 120. The processor 120 may then use the code number or other identifier to obtain, from the data storage unit 118, an associated telephone number or other address of the destination device. Communication may then be established with the destination device through a telephone or data network, the code number or other identifier may be transmitted to the destination device, and information associated with that code number or other identifier may be obtained from the destination device and transmitted to the reading device 100, such as in the manner described above.

The processor 120 may also receive fingerprint identification information read by the sensor 104 from the surface of the container. The processor may compare the read fingerprint identification information to other fingerprint identification information stored in the data storage unit 118, for example, to identify the patient for whom the medication has been prescribed or to determine whether the container is associated with a valid user of the reading device.

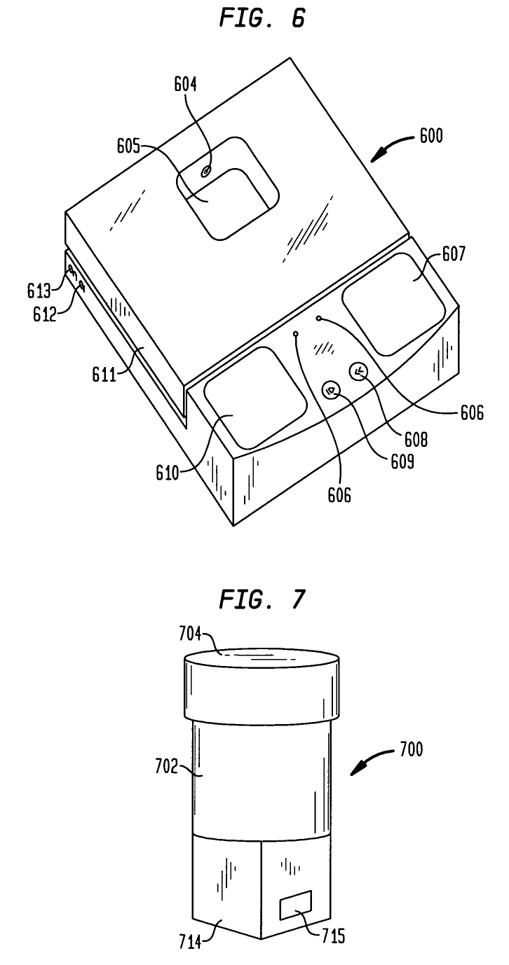

FIG. 6 shows a perspective view of a reading device in accordance with another embodiment of the invention in which information in addition to, or in place of, the code number or other identifier is stored on the container. A recess 605 is disposed in a top surface of the reading device 600 and provides a receptacle into which a container may be inserted. The container, for example, may be a prescription medication container or other container as described above. The recess 605 and the container may have complementary non-circular cross-sections to aid in opening the cap of the container when the container is inserted into the recess. As an example, recess 605 may have a substantially rectangular shape to aid in opening the container 700 shown in FIG. 7. Other shapes having at least one flat surface are also contemplated herein, such as hexagonal, octagonal, or circular with one or more flat surfaces. The container 700 includes a cap 704 as well as a holding portion 702 having one or more flat surfaces 714 which, when the container is inserted into recess 605, interact with the walls of the recess to prevent the container from rotating. Rather than having a flat surface, container 700 may have an elliptical shape, an egg shape, or another non-circular curved shape, and the recess 605 may have a similar shape. Holding the container 700 in place allows for easier opening of the cap 704.

A sensor 604 may be located, for example, along a wall of the recess 605 and positioned to read from a storage medium 715 located on the container 700. The storage medium 715 may store text data, audio data, image data, and/other types of data and, for example, may be an audio label, a semiconductor chip, a bar code label, or other electrical, magnetic, or optical storage medium. Depending on the mechanism by which storage medium 715 stores data, sensor 604 will be an appropriate sensor for reading the data. For example, when the storage medium 715 is an audio label, the sensor 604 may be an infrared sensor capable of reading the audio data. To assist in aligning the sensor 604 and the storage medium 715, the recess 605 and the flat surfaces 714 of the container 700 may be further configured so that the container can be inserted into the recess only in a single direction with the storage medium facing and/or in contact with the sensor.

Upon reading the data stored in the storage medium 715, the reading device 600 may present the data on a display 610, such as a liquid crystal display (LCD). Alternatively, or additionally, the reading device 600 may output the data as sound data using the speaker 607. A play button 609 permits the user to initiate, pause, or resume playback of the sound data. A rewind button 608 may also be provided to allow for review of the data. A connector 613 allows use of headphones in place of the speaker 607.

Reading device 600 optionally may be provided with a highly sensitive scale tray 611 for weighing the contents of the container 700. As an example, when the container holds prescription medication, the weight of the contents of the container can be determined and compared, for example, to a weight value read from the storage medium 715 to determine the number of pills remaining in the container. The container may be weighed while inserted into the recess 605 or, alternatively, may be weighed while resting on the top surface of the scale tray 611, such as when the container is oversized or odd-sized. A further connector 612 may be provided to permit connection of a hand wand (not shown) that can be used to read the storage medium of such a container. Reading device 600 may also be provided with power indicators 606 one of which, for example, serves to indicate that the reading device is turned on, and another of which, for example, indicates that the container 700 is properly seated and aligned in the recess 605 of the reading device 600.

The storage medium 715 may store information regarding, for example, the contents of the container as well as the user of the container. As an example, when the container is used to hold prescription medication, the information retained in the storage medium 715 may include the patient name, the age of the patient, the name of the medication, the prescribed dosage, the frequency at which the medication is to be taken, the manner in which the medication is to be taken, the ailment for which the medication is being prescribed, a prescribing physician's name and/or telephone number, and/or an issuing pharmacy's name and/or telephone number. Also, the information retained in the storage medium 715 may include a physical description of the medication and any markings thereon, the preferred range of dosages, a size or weight of each pill, capsule, caplet, or the like, special warnings, special instructions, an expiration date of the medication, proper storage of the medication, possible side effects of the medication, recommendations to avoid such side effects, information regarding the existence of other medications or foods that may adversely affect or counteract the prescribed medication, and/or Physician's Desk Reference (PDR) information on the prescribed medication. When the container holds a vitamin or other supplement, the information retained in the storage medium 715 may include information concerning the ingredients or related nutritional information, side effects, interactions, recommended doses, complementary supplements, ailments treated, etc., as well as some or all of the above-listed information.

Alternatively, some of the information described above may be stored in another storage unit located within the reading device 600 and/or within a destination device instead of being stored in the storage medium 715. Such information may be retrievable using, for example, the name of the medication or other medication identifier, a prescription number or other code number, or the patient's name or other patient identifier. For such an arrangement, the information retained in the storage medium 715 may be referred to as “primary information” whereas the information retrieved from the another storage unit and/or from the destination device may be referred to as “secondary information”.

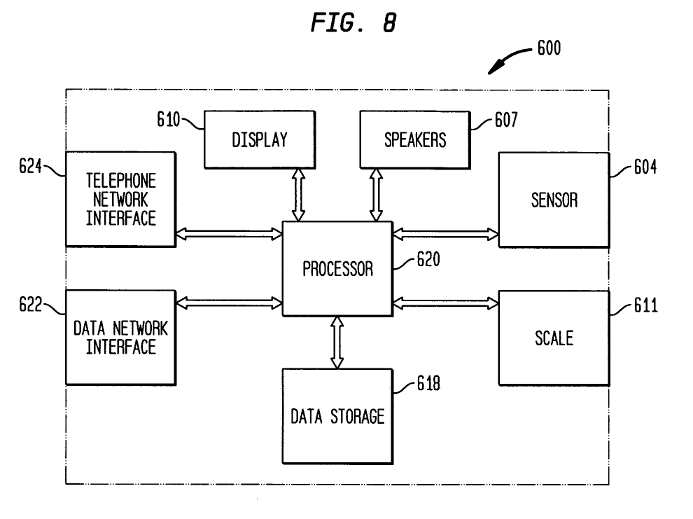

FIG. 8 shows an example of the functional units that may comprise the reading device 600 shown in FIG. 6. A CPU 620 may receive data retrieved from the storage medium 715 by the sensor 604 and from the scale 611. The CPU 620 may also control the transmission and reception of data over the telephone network or over the Internet or other data network through a data network interface 622 or a telephone network interface 624. Additionally, the CPU 620 may deliver data to the LCD display 610 and/or to the speaker 607 for output as described above. The data delivered to the speaker 607 may be data that the CPU 620 received as audio data and/or may be data that the CPU 620 received as text data and then converted to audio data. The data delivered to the display 610 may be data that the CPU 620 received as image data and/or may be data that the CPU 620 received as text data and then converted to image data. The CPU 620 may translate such text data into another selected language prior to converting the text data to audio data and/or image data.

The reading device 600 may also include terminals for a power connection, a phone line connection, and/or a data network connection, such as are described above in connection with FIG. 3. As an example, the data network connection may provide access to a local network, such as an Ethernet, by which the reading device may be initialized or may output data for delivery to, for example, a printer or a personal computer (PC). The received data may be stored in a storage unit (not shown) of the reading device 600.

Alternatively, a reading device 600 may be provided with a wireless transmitter to allow for wireless communication with a personal computer or printer. Thus, the information read from the storage medium 715 or obtained from a remote device may be viewed on the computer screen or printed out using a standard printer.

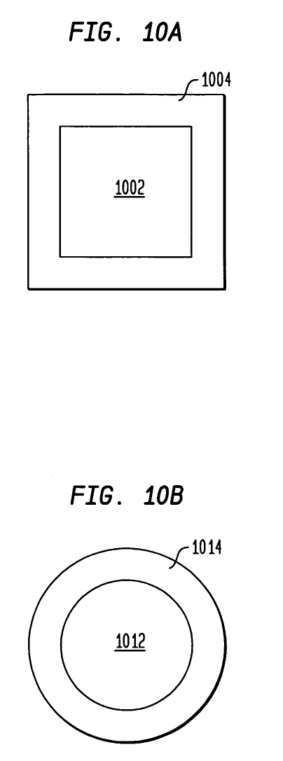

FIGS. 10A and 10B illustrate examples of audio labels that may serve as the storage medium 715. FIG. 10A shows an audio label having a square magnetic strip 1002 that is protected by a slightly larger clear plastic cover 1004. FIG. 10B shows an audio label having a circular magnetic strip 1012 protected by a slightly larger clear plastic cover 1014.

In operation, a user may place a container 700 into the recess 605 of the reading device 600 to trigger a toggle switch or other switch, which may be similar to that described above regarding FIGS. 1A and 5, to activate the sensor 604 to read the storage medium 715 and start a program in the CPU 620. The CPU 620 may then receive some or all of the primary information stored in the storage medium 715 and may store this information in a temporary memory (not shown). The CPU may also receive and store in a permanent memory 618 the weight measured by the scale 611.

Next, the CPU 620 may receive and store the secondary information obtained from other memory units within the reading device 600, such as from a read only memory (ROM) of the CPU 620. Such secondary information may be associated with some or all of the primary information. Additionally, or alternatively, the CPU 620 may send some or all of the primary information to the data network interface 622 or telephone network interface 624, which transmits this information over the Internet or other network to the destination device, and the CPU 620 may receive and store the secondary information obtained by the data network interface 622 or telephone network interface 624 from the destination device. The CPU 620 may also receive data provided by an auto-update program of the destination device. Such information may include, for example, FDA updates and warnings, PDR updates, pharmacy recalls, and/or available generics.

Also, the CPU 620 may calculate, for example, the number of doses remaining in the container 700 based on the measured weight received from the scale 611 and the stored information on the weight of each pill, capsule, caplet, or the like. Moreover, whenever the container is placed into the recess 605 of the reading device 600, the CPU may store the time at which the container was placed into the recess as well as store the measured weight of the container at that time. The CPU may then determine whether the patient has missed any doses based on, for example, the times and measured weights of two such measurements, the prescribed dosage of the medication, the frequency at which the medication is to be taken, and the weight of each pill, capsule, caplet, etc. Further, the CPU may calculate the time of the next dose based on, for example, the most recent time at which the container was placed into the recess and the frequency at which the medication is to be taken. The CPU may then alert the patient at the time when the next dose is required, for example by activating an audible alarm.

The CPU 620 may subsequently deliver some or all of the primary information, secondary information, and calculated information to the LCD or other display 610. Additionally, or alternatively, some or all such data may be delivered by the CPU 620 to speakers 607 as audio output that can be paused and replayed using controls 608 and 609 of the reading device 600. The CPU 620 may deliver such information to the user in the form of prompts. As an example, the display 610 and/or the speaker 607 may prompt the user to request that the reading device 600 notify the user at the time of the next required dose, to review the secondary information, to review online updates, to select a language, etc. Responses to the prompts may be entered using, for example, one or more keys located on the display screen 610 or elsewhere on the reading device.

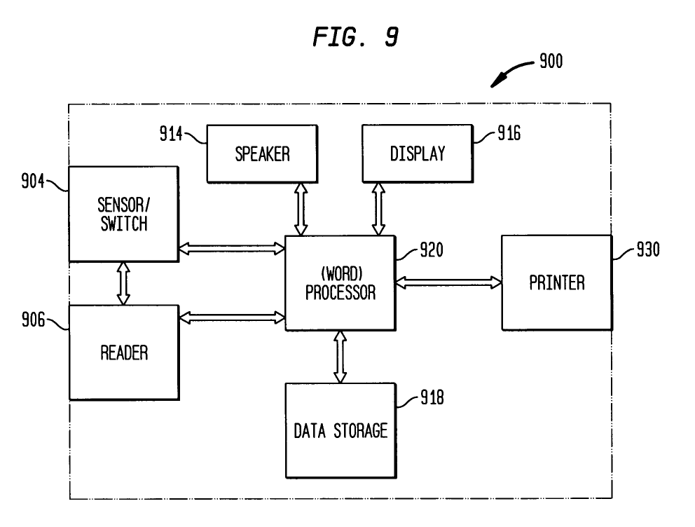

FIG. 9 shows a perspective view of a reading device 900 in accordance with yet another embodiment of the invention. The reading device 900 includes a reader 902, a switch or sensor 904, and a processor 920 which may be similar to the reader 106, the sensor or switch 104, and the processor 120 shown in FIGS. 1 and 5. At least part of a container, which may be similar to the container 200 shown in FIG. 2 or the container 700 shown in FIG. 7, may be inserted into a receptacle (not shown), which may be similar to the receptacle 102 shown in FIG. 1A and/or to the receptacle 605 shown in FIG. 6. The code number or other identifier, and/or the information associated with the code number or other identifier such as is described above, may be read by the reader 902 from a storage medium located on or in the container and then delivered to the processor 920. The processor 920, which may include a word processor program or the like, may then format some or all of the read data into a form suitable for a printer 930 and may then deliver the formatted data to the printer 930 for output. The reading device 900 may also include a speaker 914 and/or a display 916, and optionally the processor 920 may deliver some or all of the read data to one or both of the speaker 914 and display 916 for output, such as in the manner described previously.

In a variant of the above embodiments, the code number or other identifier may be stored in a one-dimensional or two-dimensional bar code affixed to the container, either in addition to or instead of the storage media described above, and the reading device may include an optical scanner for reading the bar code, either in addition to or in place of the reader described above. In another variant of these embodiments, an infrared tag may be used to store the code number or other identifier, either in addition to or in place of the above-described storage media, and an infrared scanner may be incorporated into the reading device to read the infrared tag. In a further variant of the above embodiments, a radio-frequency identification (RFID) tag may be used in addition to or in place of the storage above-described storage media, and an appropriate reader may be included in the reading device.

In a still further variant of the above embodiments, the reading device may include a USB port or other port to which a printer may be connected. The printer may be used, for example, to print out some or all of the data recorded on the storage medium, or received from the pharmacy, the pharmacy chain data center, or other data center. A print button or the like may be incorporated into the reading device to cause the data to be printed, such as in response to a question presented by the audio speaker and/or by the display. Alternatively, a print command may be included in the options shown in the display or audio menu. In yet a further variant of the above embodiments, an internal printer may be included within the reading device and operated in a similar manner to that described above.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

Also, though different embodiments described above illustrate specific features, it is within the scope of the present invention to combine or interchange different features among the various embodiments to create other variants. Any of the features in any of the embodiments can be combined or interchanged with any other features in any of the other embodiments.

1. A reading device, comprising:
a housing having a receptacle for receiving at least part of a container;
an interface operable to initiate communication with a destination device after the receptacle receives the at least part of the container; and
a reader operable to read an identifier located on the container;
the interface being operable to transmit the identifier to the destination device and to receive from the destination device information associated with the identifier.

2. A reading device according to claim 1, further comprising a switch operable to detect that the at least part of the container is received in the receptacle.

3. A reading device according to claim 1, further comprising a storage device operable to store an address of the destination device, and a processor operable to obtain the address of the destination device from the storage device.

4. A reading device according to claim 3, wherein the address of the destination device is a telephone number, and the interface includes an autodialer.

5. A reading device according to claim 3, wherein the address of the destination device is a network address, and the interface includes a network interface.

6. A reading device according to claim 5, wherein the network address is a URL for the Internet.

7. A reading device according to claim 1, wherein the container is a prescription medication container, and the information associated with the identifier is selected from the group consisting of a patient name, an age of the patient, a physician name, a physician telephone number, a pharmacy name, a pharmacy address, a pharmacy telephone number, a medication name, a medication dosage, a frequency at which the medication is to be taken, a manner in which the medication is to be taken, an ailment for which the medication is being prescribed, a physical description of the medication, a marking on the medication, a preferred range of dosages, the size of each unit of medication, a weight of each unit of medication, a special warning, a special instruction, an expiration date of the medication, a proper storage condition for the medication, a possible side effect of the medication, a recommendation to avoid a side effect of the medication, drug interaction information, a Food and Drug Administration (FDA) update, an FDA warning, recall information, Physician's Desk Reference (PDR) information on the medication, a PDR update on the medication, existence of a generic form of the medication, and combinations thereof.

8. A reading device according to claim 7, wherein the interface is operable to communicate with a pharmacy associated with the destination device.

9. A reading device according to claim 7, wherein the interface is operable to communicate with a data center associated with the destination device.

10. A reading device according to claim 1, wherein a bottom surface of the receptacle includes a material operable to frictionally engage an end portion of the container when the receptacle receives the at least part of the container.

11. A reading device according to claim 10, wherein the material is a gum or rubber.

12. A reading device according to claim 1, wherein the information obtained from the destination device includes audio data, the reading device further including a speaker operable to output the audio data.

13. A reading device according to claim 1, wherein the information obtained from the destination device includes text data, the reading device further including a processor operable to generate audio data from the text data and a speaker operable to output the generated audio data.

14. A reading device according to claim 1, wherein the receptacle and the at least part of the container have complementary non-circular cross-sections such that when the at least part of the container is received in the receptacle, the at least part of the container and the walls of the receptacle interact to prevent the container from rotating.

15. A reading device according to claim 1, wherein the identifier is read from a storage medium selected from the group consisting of an audio label, a semiconductor chip, a bar code label, an electrical storage medium, a magnetic storage medium, and an optical storage medium.

16. A reading device according to claim 15, wherein the storage medium further stores information selected from the group consisting of a patient name, an age of the patient, a physician name, a physician telephone number, a pharmacy name, a pharmacy address, a pharmacy telephone number, a medication name, a medication dosage, a frequency at which the medication is to be taken, a manner in which the medication is to be taken, an ailment for which the medication is being prescribed, a physical description of the medication, a marking on the medication, a preferred range of dosages, the size of each unit of medication, a weight of each unit of medication, a special warning, a special instruction, an expiration date of the medication, a proper storage condition for the medication, a possible side effect of the medication, a recommendation to avoid a side effect of the medication, drug interaction information, a Food and Drug Administration (FDA) update, an FDA warning, recall information, Physician's Desk Reference (PDR) information on the medication, a PDR update on the medication, existence of a generic form of the medication, and combinations thereof.

17. A reading device according to claim 1, further comprising a scale operable to weigh the container and contents of the container.

18. A reading device according to claim 17, wherein the scale is operable to weigh the container and the contents of the container after the receptacle receives the at least part of the container.

19. A reading device according to claim 1, further comprising a display operable to display at least part of the information associated with the identifier.

20. A reading device according to claim 1, wherein the at least part of the information associated with the identifier is selected from the group consisting of text data, image data, and combinations thereof.

21. A method of obtaining information relating to contents of a container, the method comprising:
storing an identifier relating to the contents of the container in a storage medium of the container;
reading the identifier;
transmitting the identifier to a destination device; and
receiving from the destination device information associated with the identifier.

22. A method according to claim 21, further comprising storing an address of the destination device, being selected from the group consisting of a telephone number, a network address, and a URL.

23. (canceled)

24. A method according to claim 21, wherein the container is a prescription medication container, and the information associated with the identifier is selected from the group consisting of a patient name, an age of the patient, a physician name, a physician telephone number, a pharmacy name, a pharmacy address, a pharmacy telephone number, a medication name, a medication dosage, a frequency at which the medication is to be taken, a manner in which the medication is to be taken, an ailment for which the medication is being prescribed, a physical description of the medication, a marking on the medication, a preferred range of dosages, the size of each unit of medication, a weight of each unit of medication, a special warning, a special instruction, an expiration date of the medication, a proper storage condition for the medication, a possible side effect of the medication, a recommendation to avoid a side effect of the medication, drug interaction information, a Food and Drug Administration (FDA) update, an FDA warning, recall information, Physician's Desk Reference (PDR) information on the medication, a PDR update on the medication, existence of a generic form of the medication, and combinations thereof.

25. A method according to claim 21, wherein the information obtained from the destination device includes audio data, the method further comprising outputting the audio data to a speaker.

26. A method according to claim 21, wherein the information obtained from the destination device is selected from the group consisting of text data and image data, the method further comprising outputting the information obtained from the destination device to a display.

27. A method according to claim 21, further comprising weighing the container and contents of the container at a selected time to obtain a weight, and recording the weight in association with the selected time after receiving the at least part of the container.

28. A reading device, comprising:
a housing having a receptacle for receiving at least part of a container;
a reader operable to read an identifier located on the container;
a storage unit operable to store an address of a destination device;
an interface operable to transmit the identifier to the destination device after the receptacle receives the at least part of the container and to receive from the destination device information associated with the identifier.

29. A reading device according to claim 28, further comprising a switch operable to detect that the at least part of the container is received in the receptacle and to activate the reader to read the identifier upon the detection.

30. A reading device according to claim 28, further comprising a processor operable to read the address of the destination device from the storage device.
